(19) United States
(12) Patent Application Publication
(10) Pub. No.: US 2004/0070974 A1
(43) Pub. Date: Apr. 15, 2004

(54) Ornamental lighting assembly

(76) Inventor: Vincent Lin, Hsin-Chu City (TW)

Correspondence Address: TROP PRUNER & HU, PC, 8554 KATY FREEWAY, SUITE 100, HOUSTON, TX, 77024, US

(21) Appl. No.: 10/270,947

(22) Filed: Oct. 15, 2002

(51) Int. Cl. F21S 13/14

(52) U.S. Cl. 362/252; 362/249; 362/806; 362/808; 362/810

(57) ABSTRACT

An ornamental lighting assembly includes a plurality of ornamental lighting units, each of which includes a series of ornamental lamps aligned in a longitudinal direction, and a pair of conductive wires extending in the longitudinal direction and interconnecting the ornamental lamps. Each of the conductive wires has two opposite connecting ends. One of the connecting ends is formed with an engaging tongue. The other one of the connecting ends is formed with an engaging groove that is capable of engaging the engaging tongue of one of the connecting ends of one of the conductive wires of an adjacent one of the ornamental lighting units.

### BACKGROUND OF THE INVENTION

1. Field of the Invention

This invention relates to a lighting assembly for ornamental use.

2. Description of the Related Art

Conventional ornamental lighting units normally include a long conductive power cord with a plurality of light bulbs connected thereto. However, the conventional ornamental lighting units can not be reassembled into a desired shape according the user's requirements.

### SUMMARY OF THE INVENTION

Therefore, it is an object of the present invention to provide an ornamental lighting assembly that is capable of overcoming the aforesaid drawback.

According to the present invention, there is provided an ornamental lighting assembly that comprises: a plurality of ornamental lighting units, each of which includes a series of ornamental lamps aligned in a longitudinal direction, and a pair of parallel conductive wires extending in the longitudinal direction and interconnecting the ornamental lamps. Each of the ornamental lamps includes a tubular supporting column and a light bulb mounted on the supporting column. The supporting column of each of the ornamental lamps is formed with two pairs of holes. Each of the conductive wires extends through a respective one of the pairs of the holes in the supporting column of each of the ornamental lamps, and is electrically connected to the light bulbs of the ornamental lamps. Each of the conductive wires has two opposite connecting ends. One of the connecting ends is formed with an engaging tongue. The other one of the connecting ends is formed with an engaging groove that is capable of engaging the engaging tongue of said one of the connecting ends of one of the conductive wires of an adjacent one of the ornamental lighting units so as to permit electrical connection between adjacent ones of the ornamental lighting units and so as to enable the ornamental lighting units to be assembled into a desired shape.

### BRIEF DESCRIPTION OF THE DRAWINGS

In drawings which illustrate embodiments of the invention,

FIG. 1 is a perspective view of a first preferred embodiment of an ornamental lighting assembly according to the present invention, which can be assembled into a circular shape for mounting on a birthday cake;

FIG. 2 is a perspective view of an ornamental lighting unit of the ornamental lighting assembly of FIG. 1;

FIG. 3 is a fragmentary schematic top view to illustrate how a conductive wire of an ornamental lighting unit is connected to a conductive wire of an adjacent ornamental unit in the ornamental lighting assembly of FIG. 1; and

FIG. 4 is a perspective view of a second preferred embodiment of the ornamental lighting assembly according to the present invention.

### DETAILED DESCRIPTION OF THE PREFERRED EMBODIMENTS

For the sake of brevity, like elements are denoted by the same reference numerals throughout the disclosure.

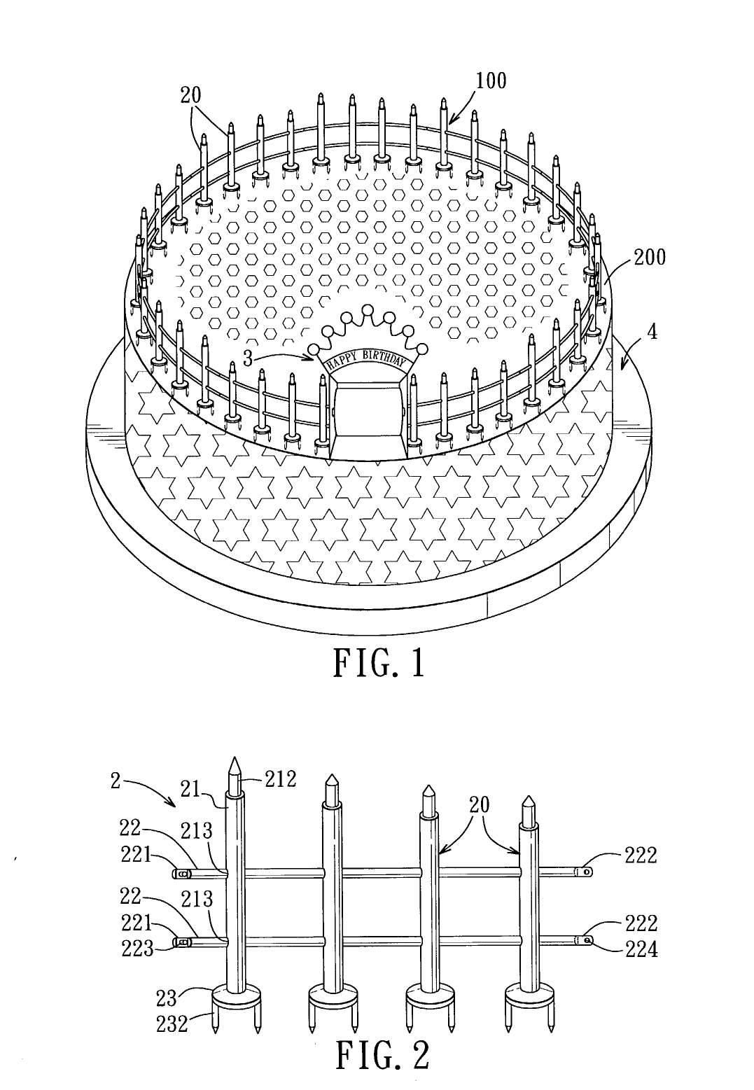

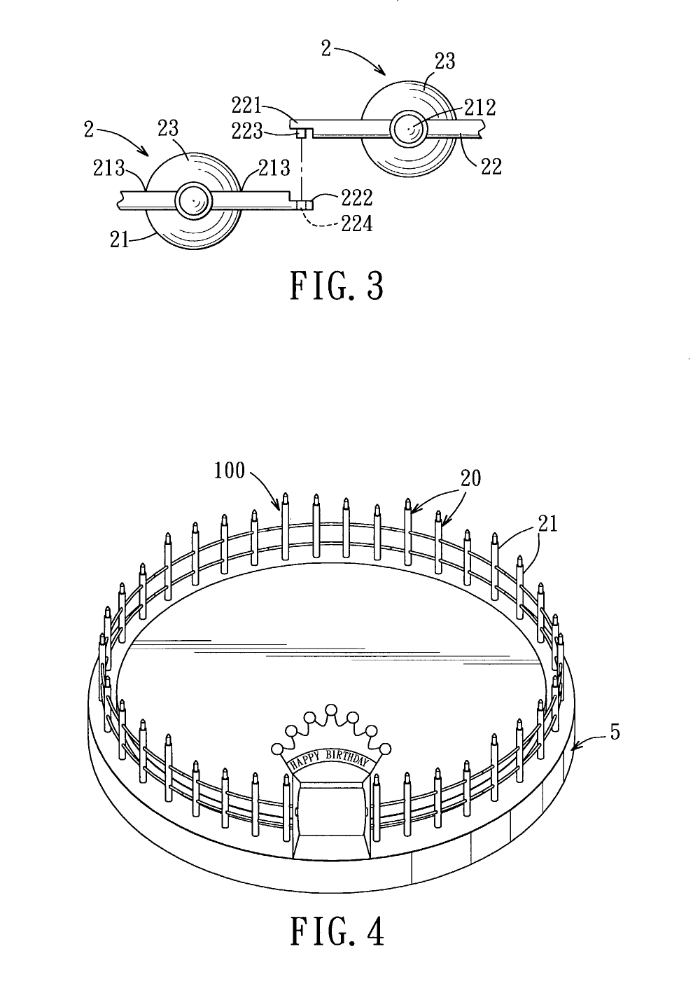

FIGS. 1 to 3 illustrate a first preferred embodiment of an ornamental lighting assembly according to this invention. The ornamental lighting assembly 100 includes: a plurality of ornamental lighting units 2, each of which includes a series of ornamental lamps 20 aligned in a longitudinal direction, and a pair of parallel conductive wires 22 extending in the longitudinal direction and interconnecting the ornamental lamps 20. Each of the ornamental lamps 20 includes a tubular supporting column 21 and a light bulb 212 mounted on the supporting column 21. The supporting column 21 of each of the ornamental lamps 20 is formed with two pairs of holes 213. Each of the conductive wires 22 extends through a respective one of the pairs of the holes 213 in the supporting column 21 of each of the ornamental lamps 20, and is electrically connected to the light bulbs 212 of the ornamental lamps 20. Each of the conductive wires 22 has two opposite connecting ends 221, 222. One of the connecting ends 221 is formed with an engaging tongue 223. The other one of the connecting ends 222 is formed with an engaging groove 224 that is capable of engaging the engaging tongue 223 of said one of the connecting ends 221 of one of the conductive wires 22 of an adjacent one of the ornamental lighting units 2 so as to permit electrical connection between adjacent ones of the ornamental lighting units 2 and so as to enable the ornamental lighting units 2 to be assembled into a desired shape.

In the first embodiment, each of the ornamental lamps 20 further includes a mounting seat 23 opposite to the respective light bulb 212 and connected to the respective supporting column 21, and an insert pin unit, in the form of a plurality of insert pins 232, extending from the mounting seat 23 for insertion into an object, such as a birthday cake 200. A battery unit 3 is used for providing electrical power to the ornamental lighting assembly. As illustrated in FIG. 1, the ornamental lighting units 2 are assembled and are arranged along a peripheral edge of the cake 4, and the battery unit 3 is disposed between and is electrically connected to two opposite ends of the assembly of the ornamental lighting units 2.

FIG. 4 illustrates a second preferred embodiment of the ornamental lighting assembly, which is similar to the previous embodiment shown in FIG. 1, except that a circular mounting base 5 is used for mounting the supporting columns 21 of the ornamental lamps 20 thereon. The supporting columns 21 of the ornamental lamps 20 are circumferentially arranged and are inserted into the mounting base 5.

Since the ornamental lighting assembly of this invention can be assembled into a desired shape according to the user's requirements, the aforesaid drawback associated with the prior art can be eliminated.

With the invention thus explained, it is apparent that various modifications can be made without departing from the spirit of the present invention. It is therefore intended that the invention be limited only as recited in the appended claims.

I claim:

1. An ornamental lighting assembly comprising:
a plurality of ornamental lighting units, each of which includes a series of ornamental lamps aligned in a longitudinal direction, and a pair of parallel conductive wires extending in the longitudinal direction and interconnecting said ornamental lamps, each of said ornamental lamps including a tubular supporting column and a light bulb mounted on said supporting column, said supporting column of each of said ornamental lamps being formed with two pairs of holes, each of said conductive wires extending through a respective one of said pairs of said holes in said supporting column of each of said ornamental lamps and being electrically connected to said light bulbs of said ornamental lamps, each of said conductive wires having two opposite connecting ends, one of said connecting ends being formed with an engaging tongue, the other one of said connecting ends being formed with an engaging groove that is capable of engaging said engaging tongue of said one of said connecting ends of one of said conductive wires of an adjacent one of said ornamental lighting units so as to permit electrical connection between adjacent ones of said ornamental lighting units and so as to enable said ornamental lighting units to be assembled into a desired shape.

2. The ornamental lighting assembly of claim 1, wherein each of said ornamental lamps further includes a mounting seat opposite to said light bulb and connected to said supporting column, and an insert pin unit extending from said mounting seat.

3. The ornamental lighting assembly of claim 1, further comprising a circular mounting base, said supporting columns of said ornamental lamps being circumferentially arranged and being mounted on said mounting base.
